(19) United States
(12) Patent Application Publication
(10) Pub. No.: US 2024/0412755 A1
(43) Pub. Date: Dec. 12, 2024

(54) BLENDED MEDIA HEAD IN A STORAGE SYSTEM

(71) Applicant: INTERNATIONAL BUSINESS MACHINES CORPORATION, Armonk, NY (US)

(72) Inventors: Jason Liang, Campbell, CA (US); Georg Lothar Lauhoff, San Jose, CA (US)

(21) Appl. No.: 18/333,138

(22) Filed: Jun. 12, 2023

(51) Int. Cl. G11B 5/008; G11B 5/02; G11B 5/127; G11B 15/18

(52) U.S. Cl. CPC G11B 5/00821; G11B 5/02; G11B 5/1272; G11B 15/1841; G11B 2005/0013

(57) ABSTRACT

In one embodiment, a head for a storage drive includes a support member having a first media facing surface, and a wafer chiplet disposed on the support member and having a second media facing surface. In one embodiment, the lateral width of the chiplet is less than the lateral width of the support member and is less than the range of tape head and magnetic tape relative lateral motion. In one aspect of the present description, the chiplet has a third media facing surface which blends with first media facing surface of the support member, and the second media facing surface of the chiplet. In one embodiment, the chiplet is disposed on the support member so that a first bank of transducers of the tape head is centered on the support member and a second bank of transducers is offset from the center of the support member.

### BACKGROUND OF THE INVENTION

### 1. Field of the Invention

The present invention relates to magnetoresistive heads for reading from and writing data to storage media in a storage drive.

### 2. Description of the Related Art

In magnetic storage systems such as tape drives, data is read from and written onto magnetic recording media through data channels utilizing magnetic transducers in a tape head. As used herein the term “magnetic” refers to the various magnetoresistive technologies. Data is written on the magnetic recording media by moving a magnetic recording transducer to a position over the media where the data is to be stored. The magnetic recording transducer then generates a magnetic field, which encodes the data into the magnetic media. Data is read from the media by similarly positioning a magnetic read transducer and then sensing the magnetic field of the magnetic media. Read and write operations may be independently synchronized with the movement of the media to ensure that the data can be read from and written to the desired location on the media.

The magnetic transducers for more than one head are typically formed on a single wafer. Arrays of magnetic transducers are typically formed in rows on the wafer which is cut to separate the rows of transducer arrays into wafer chiplets, each having one or more arrays of transducers. A tape head is formed by securing a wafer chiplet on a supporting member substrate such as a U-beam which gives the tape head structural integrity.

In one known design, the tape head span extends beyond the full width of the tape and the full range of head/tape lateral motion, such that a lateral cross-section of the tape is always supported by the tape head, either directly or on an air bearing. In this manner, concerns for possible tape damage and debris generation caused by the media hanging over the edge of the tape head can be avoided.

In another known design, the tape head is smaller than the full width of the tape and the full range of head/tape lateral. As a result, the tape is not always supported by the head but may hang over the edge of the tape head. However, edges of the tape head are smoothed for the purpose of reducing damage to the tape caused by tape head edges.

Tape drives may have different form factors such as a “full-height” tape drive and a “half-height” tape drive. At present, full-height and half-height tape drives have 32 data channels for reading and writing data.

### SUMMARY

A first embodiment provides a computer program product, device, and system employing a magnetic head in accordance with the present description and a method for operating a storage drive employing a magnetic head in accordance with the present description.

In one embodiment, a head for a storage drive includes a support member having a first media facing surface adapted to face moving media. A wafer chiplet disposed on the support member and having head transducers formed in the chiplet and adapted to at least one of read data from and write data to media moving past the head transducers, further has a second media facing surface adapted to face moving media.

In an embodiment in which the head is a tape head, and the media is magnetic tape and is adapted to move in a linear direction, the support member and the wafer chiplet each have lateral widths in a lateral direction transverse to the tape linear direction. In this embodiment, the lateral width of the chiplet is less than the lateral width of the support member.

In an embodiment having tape head actuators adapted to cause lateral motion of the tape head relative to the magnetic tape, in a lateral direction transverse to the tape linear direction, and over a predetermined range of tape head and magnetic tape relative lateral motion, the wafer chiplet has a lateral width in a lateral direction transverse to a tape linear direction. In this embodiment the lateral width of the chiplet is less than the predetermined range of tape head and magnetic tape relative lateral motion.

In one aspect of the present description, the chiplet has a third media facing surface adapted to face moving magnetic tape. In this embodiment, the third media facing surface is a curved surface positioned intermediate the first media facing surface of the support member, and the second media facing surface of the chiplet.

In one embodiment in which the support member defines a center and the tape head has a first bank of transducers and a second bank of transducers, the chiplet is disposed on the support member so that the first bank of transducers of the tape head is centered on the support member and the second bank of transducers is offset from the center of the support member.

In an embodiment in which the first media facing surface defines a first plane, and the second media facing surface defines a second plane offset from the first plane, the third media facing surface is curved to transition from the second plane to the first plane.

In an embodiment in which the support member is a ceramic U-beam which defines a lateral axis, the curved shape of the third media facing surface is a polished surface which is curved both in a direction parallel to the U-beam lateral axis and in a direction transverse to the U-beam lateral axis.

In another aspect of the present description, the support member has a fourth media facing surface adapted to facing moving magnetic tape. In this embodiment, the chiplet has a first end adjacent the support member first media facing surface and a second end adjacent the support member fourth media facing surface. Furthermore, the chiplet has a fifth media facing surface adapted to face moving magnetic tape. In addition, the fifth media facing surface is a curved surface positioned intermediate the second and fourth media facing surfaces.

Other aspects and advantages may be provided, depending upon the particular application.

### BRIEF DESCRIPTION OF THE DRAWINGS

FIG. 1 is a schematic diagram of a storage system employing a tape head in accordance with one embodiment of the present disclosure.

FIG. 2A is a top view of a tape head for a half-height tape drive in accordance with one embodiment of the present description.

FIG. 2B is a cross-sectional view of the tape head of FIG. 2A, as viewed along the line 2B-2B of FIG. 2A.

FIG. 3 is a top view of a row of tape head chiplets cut from a wafer.

FIG. 4A is a top view of a tape head utilizing a chiplet of FIG. 3 in accordance with the present description, for a full-height tape drive.

FIG. 4B is a cross-sectional view of the tape head of FIG. 4A, as viewed along the line 4B-4B of FIG. 4A.

FIGS. 5A-5F depict various stages of fabrication of the tape head of FIGS. 2A, 2B in accordance with one embodiment of the present description.

FIG. 6 is a cross sectional view of the tape head of FIG. 5F as viewed along the lines 6-6 in FIG. 5F.

FIG. 7A is a top view of an embodiment of a tape head for a full-height tape drive in accordance with the present description.

FIG. 7B is a cross-sectional view of the tape head of FIG. 7A, as viewed along the line 7B-7B of FIG. 7A.

FIG. 8A is a top view of yet another embodiment of a tape head for a half-height tape drive in accordance with the present description.

FIG. 8B is a cross-sectional view of the tape head of FIG. 8A, as viewed along the line 8B-8B of FIG. 8A.

FIG. 9 depicts one embodiment of operations of a tape drive employing a tape head in accordance with the present description.

### DETAILED DESCRIPTION

Described embodiments provide improvements to computer technology for storing and retrieving data in storage systems such as tape drives, for example, having a tape head which reads data from or writes data to a magnetic tape media. In one embodiment, a tape head has media facing surfaces on not only the chiplet of the tape head, but also on the U-beam support member supporting the chiplet. As explained in greater detail below, such an arrangement provides a number of advantages. For example, because the U-beam support member itself has a media facing surface, the full lateral width of the chiplet can be narrower than the full lateral width of the U-beam member such that chiplets having a reduced size as compared to the U-beam support member may be utilized.

In the illustrated embodiment, tape drive actuators move the head laterally in a direction which is generally orthogonal to that of the linear direction of the tape. This lateral physical movement of the head relative to the tape produces an apparent lateral motion of the head and tape relative to each other over a range of head/tape relative lateral motion. In one aspect of a tape head in accordance with the present description, the full lateral width of the chiplet is less than the full range of head/tape relative lateral motion. However, within this full range of lateral relative motion, the relative movement of the tape is limited so that it is passing over one or more of the U-beam media facing surface and a chiplet media facing surface. Thus, in one embodiment, the full range of head/tape relative lateral motion does not extend beyond the media facing surfaces of the tape head. As a result, in this embodiment, the lateral cross-section of the tape does not overhang the lateral ends of the tape head during read, write or transport operations of the tape.

Media facing surfaces as that term is used herein, are sometimes referred to as “tape bearing surfaces.” While the term “tape bearing surface” appears to imply that the surface facing the tape is in physical contact with the tape, this is not necessarily the case. Rather, typically only a portion of the tape may be in contact with the tape bearing surface, constantly or intermittently, with other portions of the tape riding (or “flying”) above the tape bearing surface on a layer of air, sometimes referred to as an “air bearing” or a cushion of air. As used herein, a tape described as “passing” over a media facing surfaces includes the tape either being in contact with the media facing surface or the tape flying over the media facing surface.

In another aspect, a media facing surface of the chiplet of the tape head is smoothly blended at one end, to the media facing surface of the U-beam support member, and is also smoothly blended at the other end to another media facing surface of the chiplet. As a result, damage to the media can be reduced or eliminated notwithstanding that the lateral cross-section of the media can overhang one end of the chiplet in this embodiment.

In yet another aspect, a U-beam support member itself having a media facing surface also provides increased flexibility for manufacturing tape heads having varying numbers of transducers. For example, a chiplet having two banks of transducers, may be used for both half-height applications in which just one bank of transducers is active, and full-height applications in which both banks of transducers are active. As a result, a potential cost savings may be realized due to use of common chiplet and U-beam support member components in both half-height and full-height tape heads.

In one embodiment of head fabrication in accordance with the present description, a chiplet having two banks of transducers, is disposed on the U-beam support member so that one bank, the active bank of transducers of the chiplet is laterally centered on the midpoint of the full range of head/tape relative lateral motion. Such centering of the active bank is facilitated by the provision of the U-beam media facing surface, and assures efficient use of the tape for read and write operations over the full range of head/tape relative lateral motion.

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

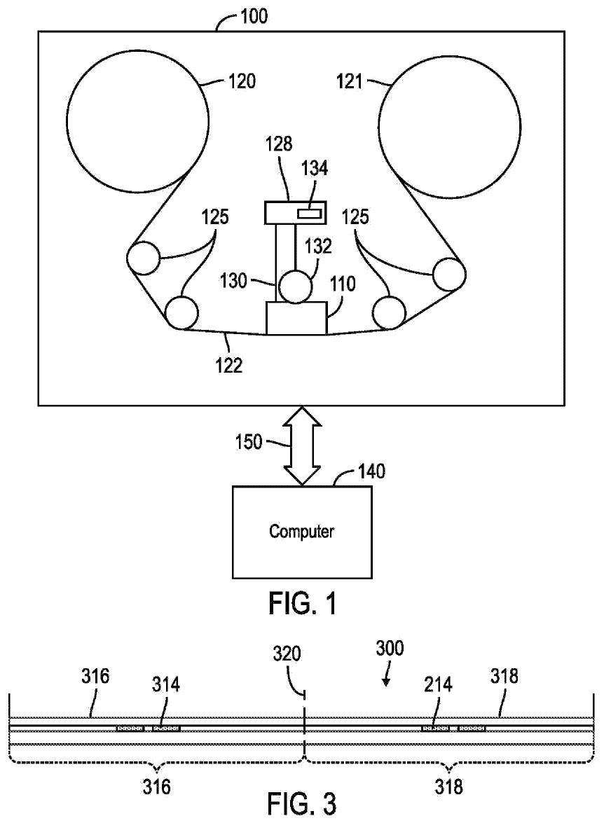

FIG. 1 illustrates a storage system which includes a tape drive 100 employing a blended tape head 110 in accordance with the present description. While one specific implementation of a tape drive is shown in FIG. 1, it should be noted that the embodiments described herein may be implemented in the context of any type of tape drive system employing magnetoresistive tape media. In some embodiments, the tape drive 100 may represent a half-height tape drive and in other embodiments, the tape drive 100 may represent a full-height tape drive. Furthermore, it is appreciated that embodiments described herein may be implemented in other types of storage devices having write or read heads for storing or retrieval of data on other types of magnetoresistive media, such as disk drives having sliders, for example. As used herein, the term “magnetoresistive” or more simply “magnetic” is applicable to heads and media employing various magnetoresistive technologies including Giant Magnetoresistive (“GMR”), Tunneling Magnetoresistive (“TMR”), and Magnetoresistive (“MR”) technologies.

As shown, a tape supply cartridge 120 and a take-up reel 121 are provided to support a magnetoresistive tape 122 referred to herein as magnetic tape, or simply tape 122. One or more of the reels may form part of a removable cartridge and are not necessarily part of the system 100. The tape drive, such as that illustrated in FIG. 1, may further include drive motor(s) to drive the tape supply cartridge 120 and the take-up reel 121 to move the tape 122 over the tape head 110. The head 110 includes one or more arrays of transducers such as reader, writer, or servo transducers.

Guides 125 guide the tape 122 across the tape head 110. Such tape head 110 is in turn coupled to a controller 128 via a cable 130. The controller 128 typically controls head functions such as servo following, writing, reading, etc. The controller may operate under logic known in the art or which may be subsequently developed, modified as appropriate for the tape head 110 of the present description, as well as any logic disclosed herein. The cable 130 may include read/write circuits to transmit data to the head 110 to be recorded on the tape 122 and to receive data read by the head 110 from the tape 122. An actuator 132 is configured to control position of the head 110 relative to the tape 122. An interface 134 may also be provided for communication between the tape drive and a host (integral or external) or other computer 140 of the storage system to send and receive the data and for controlling the operation of the tape drive and communicating the status of the tape drive to the host, all as will be understood by those of skill in the art.

The storage system represented by the tape drive 100 may include an automated tape library for example, having one or more tape drives 100 docked in the library system. An example of such a tape library is an LTO tape library such as the TS4500 marketed by IBM, which has been modified to include tape drives having tape heads in accordance with the present description.

The computer 140 represents one or more of host computers, user computers, workstations, storage controllers, or other computers coupled to each other and to the tape drive 100 by one or more networks 150. In one embodiment, a host computer 140 coupled to the tape drive 100 receives requests over a network from user computers to access data in tape cartridges 120 internal to the tape library using tape drives 100 of the tape library.

The computer 140 may be an enterprise computer system in which aspects of a storge system in accordance with the present description may be realized. Examples of enterprise-wide applications include, without limitation, banking transactions, payroll, warehouse, transportation, and batch jobs.

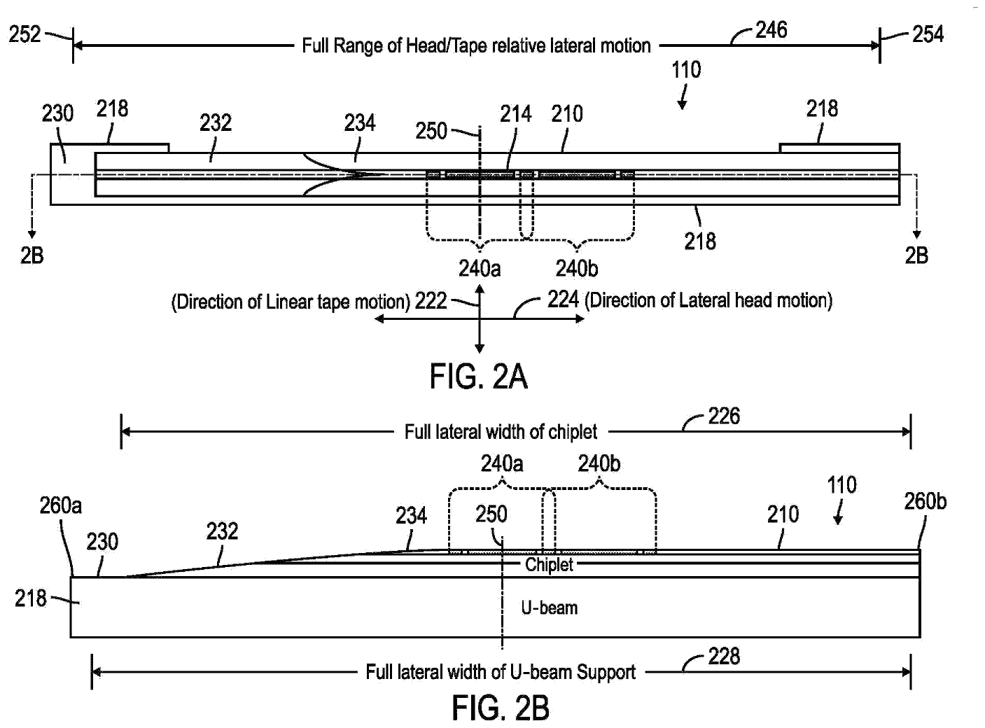

FIG. 2A is a top view of one embodiment of the head 110 in accordance with the present description and FIG. 2B is a lateral cross-sectional view of the head 110 of FIG. 2A, as viewed along the lines 2B-2B of FIG. 2A. Representations of components have been simplified and proportions varied within the figures for purposes of clarity in presentation.

In this embodiment, the head 110 includes a wafer chiplet 210 having magnetoresistive transducers 214 formed in a gap therein. The chiplet 210 is cut from a wafer which includes a suitable substrate material and is disposed on and supported by a support structure or member 218, which in the illustrated embodiment, is a ceramic U-shaped member referred to herein as a U-beam, to form the tape head 110. It is appreciated that the support member 218 may have other shapes and may be constructed of other wear resistant materials.

The magnetic tape 122 (FIG. 1) passes over the top of the head 110 in a linear direction which is generally parallel to the direction represented by an arrow 222 in FIG. 2A. The linear motion of the tape 122 is provided by linear actuators which includes reels 120, 121 (FIG. 1). The linear actuators are configured to move the magnetic tape 122 in the linear direction represented by the arrow 222 past the tape head 110. In this embodiment, the arrow 222 represents the motion of the tape caused when being wound and unwound from the reels 120, 121 of the tape drive 100.

Relative motion between the tape 122 and the head 110 is also provided by the tape drive lateral actuators 132 (FIG. 1) which are configured to cause lateral motion of the head 110 in a direction represented by an arrow 224 which is generally parallel to the lateral head motion. The direction of lateral motion as represented by the arrow 224 is generally transverse to, or in this embodiment, orthogonal to that of the linear direction 222 of the tape 122.

As the tape 122 and the head 110 move relative to each other, the tape 122 and the head 110 generally are not always in direct contact with each other. Instead, the head 110 may fly on a cushion of air which spaces the tape 122 from media facing surfaces of the tape head 110 which are adapted to face moving magnetic tape of the tape drive. Thus the tape 122 can be supported by a cushion of air positioned over media facing surfaces on the head 110. The transducers 214 are adapted to at least one of read data from and write data to the magnetic tape 122 moving past the tape head transducers 214 of the head 110.

In one aspect of tape head fabrication in accordance with the present description, the head 110 has media facing surfaces supporting a cushion of air on not only the chiplet 210 but also on the U-beam support member 218 supporting the chiplet 210. In one embodiment, the full lateral width of the chiplet 210 as measured in a direction parallel to the lateral direction 224 (FIG. 2A) and as represented by the arrow 226 (FIG. 2B) is, in one embodiment, narrower in width than the full lateral width of the U-beam member 218 as measured in a direction parallel to the lateral direction 224 (FIG. 2A) and as represented by the arrow 228 and as best seen in FIG. 2B. The lateral widths as represented by the arrows 226, 228, are oriented in a direction generally parallel to the lateral direction of movement of the tape head 110 as represented by the arrow 224.

In this embodiment, the U-beam support 218 itself has a media facing surface 230 to which a media facing surface 232 of the chiplet 210 is smoothly blended at one end of the media facing surface 232. The other end of the media facing surface 232 of the chiplet 210 is smoothly blended to a top media facing surface 234 of the chiplet 210.

As explained in greater detail below, such an arrangement provides increased flexibility for manufacturing tape heads having varying numbers of channels and transducers. For example, a chiplet having two banks of transducers, may be used for both single bank and dual bank tape heads, leading to potential cost savings due to use of common chiplet and U-beam support member components in both half-height and full-height tape drives. Furthermore, as best seen in the cross-sectional view of FIG. 2B, smoothly blending media facing surfaces of the chiplet 210 together with media facing surface of the U-beam support member 218, reduces or eliminates tape damage due to the tape moving past an edge of the chiplet.

In the embodiment of FIGS. 2A, 2B, the chiplet 210 has two banks of transducers 214, that is, bank 240a and 240b. However, in one aspect of tape head fabrication in accordance with the present description, only the bank 240a is active in read, write and servo operations such that the tape head 110 is effectively a tape head of 32 channels in this example, notwithstanding that the chiplet 210 is fabricated with two banks 240a, 240b. Thus, a chiplet such as the chiplet 210 having two banks 240a, 240b of transducers, may be used for both single bank and dual bank tape heads, leading to potential cost savings due to use of common chiplet components in tape heads for both half-height and full-height tape drives. One application of the 32 data channel tape head 110 is use in a half-height tape drive having 32 data channels. Hence, the tape head 110 is frequently referred to herein as a “half-height tape head” 110. However, it is appreciated that the tape head 110 may also be used in a full-height tape drive, for example.

As noted above, tape drive actuators 132 (FIG. 1) move the head 110 laterally in a direction which is generally orthogonal to that of the linear direction 222 of the tape 122, as represented by the arrow 224 which is generally parallel to the lateral head motion. The physical movement of the head 110 in the lateral direction produces an apparent lateral motion of the tape 122 relative to the head 110 over a range of tape/head relative lateral motion, as represented by an arrow 246 (FIG. 2A). The full range of head/tape relative lateral motion as indicated by the arrow 246 has a midpoint as indicated by an imaginary center plane 250.

In one aspect of head fabrication in accordance with the present description, the full lateral width of the chiplet 210 as represented by the arrow 226 (FIG. 2B), is less than the full range of head/tape relative lateral motion as represented by the arrow 246 (FIG. 2A). In this embodiment, lateral movement of the head 110 relative to the tape 122 is limited within this range so that the lateral cross-section of tape is always flying over or in contact with one or more of the U-beam media facing surface 330 and the chiplet media facing surfaces 232, 234. Thus, the full range of head/tape relative lateral motion is constrained between two boundaries indicated at 252 (FIG. 2A), 254, respectively, and does not extend beyond the media facing surfaces of the tape head 110. As a result, in this embodiment, the lateral cross-section of the tape does not overhang the lateral ends 260a, 260b (FIG. 2b) of the tape head 110 during read, write or transport operations of the tape 122.

In the illustrated embodiment, the imaginary center plane 250 representing the midpoint of the full range 246 of head/tape relative motion, coincides with the lateral center of the U-beam support member 218. It is appreciated that in other embodiments, the lateral center of the U-beam support member 218 may be offset with respect to the imaginary center plane 250 representing the midpoint of the full range 246 of head/tape relative motion, depending upon the particular application.

In one aspect of head fabrication in accordance with the present description, the chiplet 210 is disposed on the U-beam support member 218 so that the active bank 240a of transducers 214 of the chiplet 210 is laterally centered on the midpoint of the full range 246 of head/tape relative lateral motion as indicated by the imaginary center plane 250. As a result, a portion of the tape 122 is overflying the active bank 240a over the full range 246 of head/tape relative lateral motion for efficient read and write operations. It is appreciated that in other embodiments, the active bank 240a of transducers 214 of the chiplet 210 may be somewhat off-centered with respect to the midpoint of the full range 246 of head/tape relative motion as indicated by the imaginary center plane 250. However, in such embodiments, a portion of the tape 122 is generally overflying the active bank 240a over a substantial portion of the full range 246 of head/tape relative lateral motion.

Conversely, because the inactive bank 240b of transducers 214 is substantially offset with respect to the imaginary center plane 250 representing the midpoint of the full range 246 of head/tape relative motion, a portion of the tape 122 overflying the inactive bank 240b over much of the full range 246 of head/tape relative lateral motion is not assured. However, because the bank 240b is inactive, read and write operations of the half-height head 110 are not affected by the inactive bank 240b of transducers being offset with respect to the center of the U-beam support member 218 or the full range 246 of head/tape relative lateral motion.

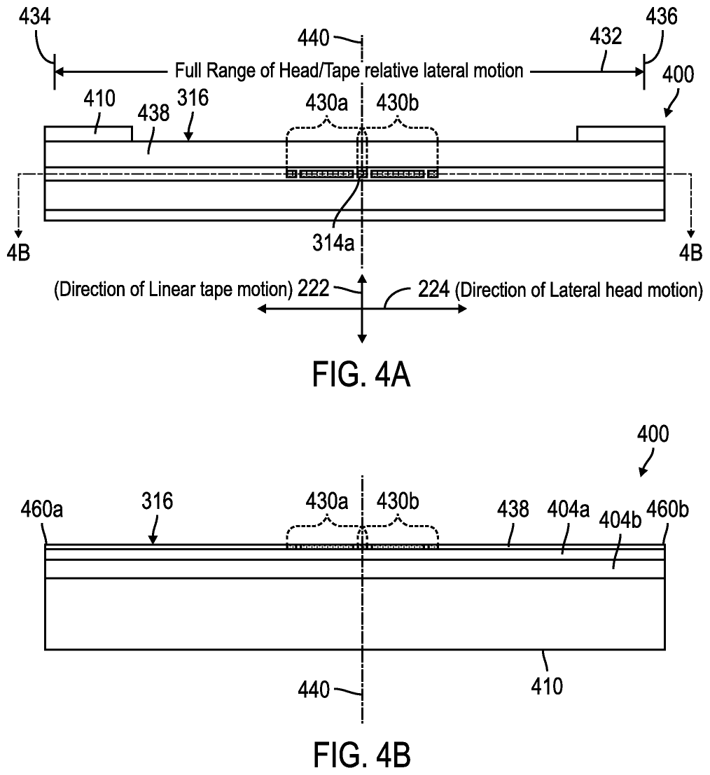

FIG. 3 depicts an example of a row 300 of transducers 214, 314 formed on a wafer using techniques currently known or which may be subsequently developed. The row 300 has been cut from the wafer and, in this example, two chiplets 316, 318 may be cut from the row 300 at a cut line indicated at 320. In this embodiment, each chiplet 316. 318 has two banks of transducers for 32 channels, for example, for each bank, such that each chiplet 316, 318 may support a total of 64 channels, for example, in a full-height tape head application, for example. Thus, the chiplets 316, 318 are substantially identical in this embodiment.

However, as described below, in one aspect of a tape head fabrication in accordance with the present description, one chiplet such as the chiplet 316, for example, may be used to fabricate a tape head having 64 active channels, for example, and the other chiplet such as the chiplet 318, for example, cut from the same wafer and substantially identical to the chiplet 316, may be used to fabricate a tape head having 32 active channels, for example, notwithstanding that the chiplets 316, 318 may be identical. As a result, potential cost savings may be realized due to interchangeable use of common components such as the chiplets 316, 318 in tape heads for both 32 channel and 64 channel applications and for both half-height and full-height tape drives.

As noted above, in one embodiment, a 32 channel head used in a half-height tape drive and a 64 channel head used in a full-height tape drive, are made from identical or common wafer elements or chiplets. It should be appreciated that this is but one example of usage of common wafer elements for media head design in accordance with the present description. It is appreciated herein that usage of common wafer elements in accordance with the present description can be applied to additional designs and to future generations of media heads such as heads having 96 channels, 128 channels, etc. Thus, blended media heads, for example, in accordance with the present description can be used in a variety of applications where multiple product models and generations can be achieved from the same wafer design in which each product employs predetermined numbers of banks of elements, portions of elements, or all of the elements, depending upon the particular application.

In this embodiment, the chiplets 316, 318 each have a lateral width of 22.5 mm or 47 mm combined prior to being cut apart. It is appreciated that dimensions and other physical characteristics for chiplets for full-height and half-height applications of head fabrication in accordance with the present description, may vary and need not be identical, depending upon the particular application.

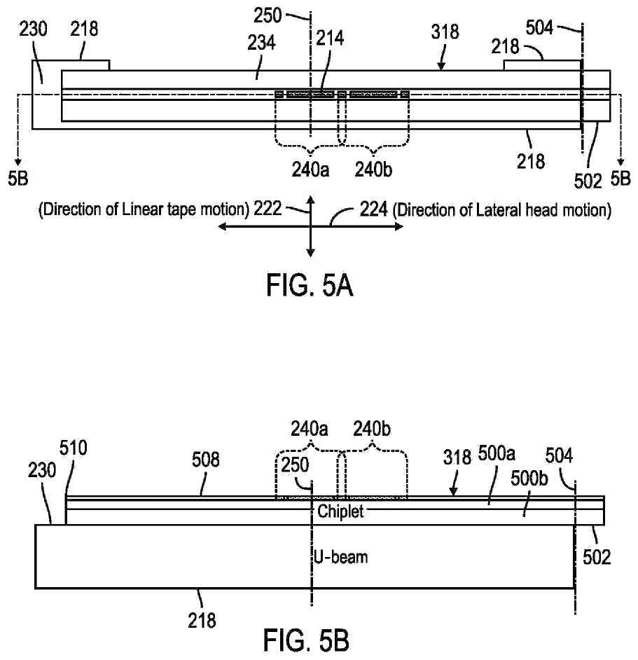

FIGS. 4A, 4B show a design of a tape head 400 which includes the chiplet 316 (FIG. 3) disposed on a U-beam support member 410. In accordance with conventional designs, the chiplet 316 for the tape head 400 has the same lateral width as the U-beam support member 410. By comparison, for the tape head 110 (FIGS. 2A, 2B) in accordance with the present description, the chiplet 210 for the tape head 110 is narrower in lateral width as compared to its U-beam support member 218.

As previously noted, the chiplet 316 is cut from a wafer, and has various chiplet layers as represented by a top layer 404a (FIG. 4B) and a bottom layer 404b. Although FIG. 4B depicts only two layers, 404a, 404b for purposes of simplicity, it is appreciated that the chiplets 316.318 may have numerous layers, depending upon the particular application.

The chiplet 316 like the chiplet 318 cut from the same wafer, has two banks of transducers 314, indicated at 430a and 430b in FIGS. 4A, 4B. In this example, both banks 430a, 430b of transducers are active, to provide for 64 active channels for the tape head 400. One application of the tape head 400 is use in a full-height tape drive, for example, having 64 data channels, for example. Hence, the tape head 410 is frequently referred to herein as a “full-height tape head” 410. However, it is appreciated that the tape head 410 may also be used in a half-height tape drive, for example.

A magnetic tape similar to the magnetic tape 122 (FIG. 1) passes over the top of the full-height head 400 in a linear direction which is generally parallel to the direction represented by the arrow 222 in FIG. 4A. Thus, the arrow 222 represents the motion of the tape caused by the tape being wound and unwound from tape drive reels similar to the reels 120, 121 of the tape drive 100. Relative motion between the tape and the full-height head 400 is also provided by tape drive actuators similar to the actuators 132 of the tape drive 100, which move the head 400 laterally in a direction which is generally transverse, or orthogonal in this example, to that of the linear direction 222 of the tape, as represented by an arrow 224 which is generally parallel to the lateral head motion.

The physical movement of the head 400 in the lateral direction 224 produces an apparent lateral motion of the tape relative to the head 400 over a range of head/tape relative lateral motion, as represented by an arrow 432. The full range 432 of head/tape relative lateral motion is constrained between two boundaries indicated at 434, 436 (FIG. 4A), respectively, and does not extend beyond the media facing surfaces of the tape head 400. As a result, the lateral cross-section of the tape does not overhang the lateral ends 460a, 460b (FIG. 4B) of the tape head 400 during read, write or transport operations of the tape.

In this example, the U-beam support member 410 itself lacks a media facing surface. Instead, the chiplet 316 has a media facing surface 438 which extends the full lateral width of the chiplet 316 overlying the U-beam support member 410 in a manner similar to that of known tape heads. As a result, the media facing surface 438 of the full-height head 400 supports a tape either directly or on a cushion of air only on the chiplet 316 itself and not on a surface of the U-beam support member 410. By comparison, the U-beam support member 218 for the tape head 110 (FIGS. 2A, 2B) in accordance with the present description, has itself a media facing surface 230 which permits a reduction in lateral width of the chiplet as previously described.

Thus, in this example, the lateral cross-section of the tape always flies over or in contact with the chiplet media facing surface 438. Thus, the full range 432 of tape/head relative lateral motion is constrained between two boundaries indicated at 434, 436, respectively, and does not extend beyond the media facing surface 438 of the tape head 400. As a result, in this example, the lateral cross-section of the tape does not overhang the lateral ends 460a, 460b (FIG. 4B) of the tape head 400 during read, write or transport operations of the tape 122 as noted above. As a consequence, blending of the edges at the ends of the full-height tape head 400 may be omitted, if appropriate.

The full range of head/tape relative lateral motion as indicated by the arrow 432 (FIG. 4A) has a midpoint as indicated by an imaginary center plane 440. In the full-height example of FIG. 4A, the two banks 430a, 430b of transducers 314 are arranged symmetrically about the lateral movement range imaginary center plane 440 and share a set of servo transducers 314a between them. By comparison, in the half-height head 110 of FIG. 2A, the active bank 240a of transducers 214 is centered on the imaginary center plane 250 at the midpoint of the full range 246 of head/tape relative lateral motion.

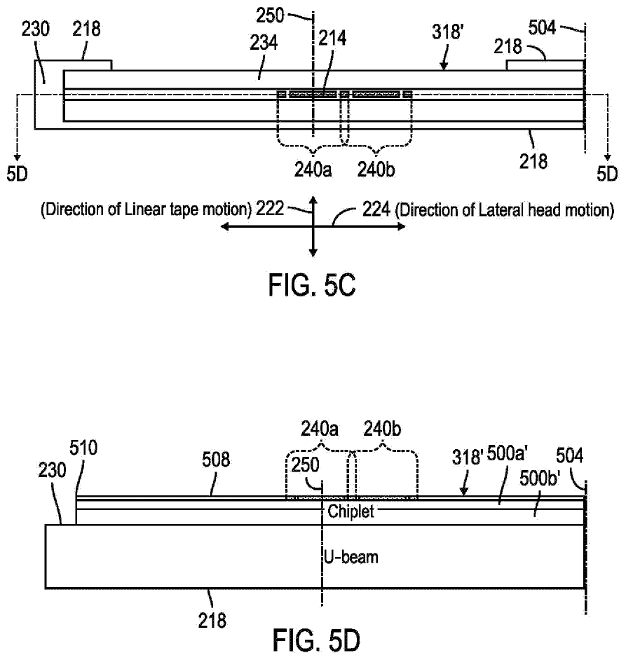

FIGS. 5A-5F depict one example of operations employing head fabrication in accordance with the present description, for fabricating the half-height head 110 of FIGS. 1, 2A, 2B using the chiplet 318 (FIG. 3) cut from the same wafer as the chiplet 316. The chiplet 318, like the chiplet 316, has various layers as represented by a top layer 500a (FIG. 5B) and a bottom layer 500b. FIG. 5B depicts just two chiplet layers, 500a, 500b for purposes of simplicity but may have numerous layers, depending upon the application. Thus, it is appreciated that the number of layers in the chiplet 318 may vary. depending upon the particular application.

As previously mentioned, the chiplet 318, like the chiplet 316, has two banks of transducers indicated at 240a, 240b for the chiplet 318. Each bank 240a, 240b is capable of providing 32 channels such that the chiplet 318 can support a total of 64 channels in an appropriate tape head application. However, in this embodiment, the chiplet 318 is adapted for, in accordance with tape head fabrication in accordance with the present description, a half-height head application having just 32 active channels instead of 64 active channels. Accordingly, in this embodiment only the bank 240a will be active and the bank 240b will be inactive.

FIGS. 5A, 5B show the chiplet 318 (FIG. 3) disposed on the U-beam support member 218. In this example, the U-beam support member 218 for the half-height tape head 110 (FIG. 2A) has the same lateral width as the U-beam support member 410 (FIGS. 3A, 3B) for the full-height tape head 300. Here too, it is appreciated that dimensions and other physical characteristics for support members for full-height and half-height applications of head fabrication in accordance with the present description, may vary and need not be identical, depending upon the particular application.

As best seen in FIG. 5B, the chiplet 318 is not centered on the U-beam support member 218. Instead, the chiplet 318 is laterally offset with respect to the U-beam support member 218 so that the active bank 240a of transducers 214 of the chiplet 210 is laterally centered on the midpoint of the full range 246 (FIG. 2A) of head/tape relative lateral motion as indicated by the imaginary center plane 250 (FIGS. 2A, 5A). Because the chiplet 318 is offset with respect to the U-beam support member 218, a portion 502 of the chiplet 318 extends beyond one end of the U-beam support member 218 as represented by plane 504 which is transverse to the lateral direction as represented by arrow 224. In one embodiment, the portion 502 of the chiplet 318 which extends beyond one end of the U-beam support member 218 may be removed using any suitable fabrication technique such as cutting, sanding, or polishing, for example. Once the portion 502 of the chiplet 318 has been removed as shown in FIG. 5C, the chiplet layers 500a, 500b (FIG. 5B) are truncated as indicated at 500a′ (FIG. 5D), 500b′, and the end of the remaining chiplet 318′ is coplanar with the end of the U-beam support member 218 as represented by the plane 504. It is appreciated that in other embodiments, the end of the truncated chiplet 318′ need not be coplanar with the end of the U-beam support member 218 but may instead extend beyond the end of the U-beam support member 218 as indicated in FIG. 5A, or may be recessed with respect to the end of the U-beam support member 218, depending upon the particular application.

In one aspect of tape head fabrication in accordance with the present description, by offsetting the center of the chiplet 318′ with respect to the center of the U-beam support member 218, a portion 230 of the upper surface of the U-beam support member 218 is not covered by the chiplet 318′ when disposed on the U-beam support member 218. As a result, in this embodiment, the exposed portion 230 of the U-beam support 218 provides the media facing surface 230 of the U-beam support member 218 as described above in connection with FIGS. 2A-2B.

It is appreciated that the top surface 508 of the truncated top layer 500a′ of the chiplet 318′ (FIG. 5C) has a relatively sharp edge 510 before transitioning to the media facing surface 230 of the U-beam support member 218. In another aspect of tape head fabrication in accordance with the present description, the end of the truncated chiplet 318′ is smoothly blended adjacent the U-beam support member media facing surface 230. The truncated chiplet 318′, once smoothly blended, is indicated as the smoothly blended chiplet 210 in FIGS. 2A, 2B, 5E, 5F and 6. Once the smoothing is complete, the chiplet layers 500a′ (FIG. 5D), 500b′ are further truncated as indicated at 500a″ (FIG. 5F), 500b′.

The smoothly blended end of the chiplet 210 provides an additional media facing surface 232 of the chiplet 210 in which the media facing surface 232 is also adapted to face moving magnetic tape. In this embodiment, the media facing surface 232 of the blended chiplet 210, is a laterally curved surface as best seen in the lateral cross-sectional view of FIG. 5F, and is positioned intermediate the media facing surface 230 of the U-beam support member 218, and the media facing surface 234 of the blended chiplet 210. As best seen in FIG. 5F, the lateral outboard end of the media facing surface 232 of the blended chiplet 210, is curved to smoothly blend with the media facing surface 230 of the U-beam support member 218. In addition, the lateral inboard end of the media facing surface 232 of the blended chiplet 210, is curved to smoothly blend with the media facing surface 234 of the top layer 500″ of the blended chiplet 210.

In the illustrated embodiment, the media facing surface 234 of the top layer 500″ of the blended chiplet 210 defines a plane, and the media facing surface 230 of the U-beam support member 218 defines a second plane offset with respect to and generally parallel to, the plane of the media facing surface 234 of the chiplet 210. FIG. 5F depicts a lateral axis 520 of the U-beam support member 218, which is generally parallel to the direction 224 (FIG. 5C) of lateral head motion. In this embodiment, the blended media facing surface 232 of the chiplet 210 provides a surface curved in cross-sections parallel to the U-beam axis 520 to smoothly transition from the plane of the media facing surface 234 of the chiplet 210, to the media facing surface 230 of the U-beam support member 218 as best seem in FIG. 5F.

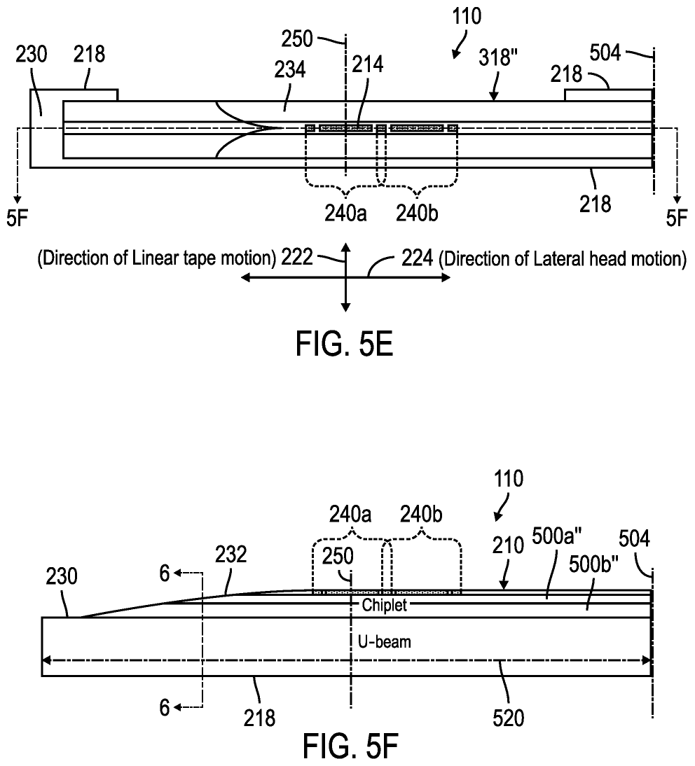

The blended media facing surface 232 of the chiplet 210 is also curved in cross-sections transverse to the U-beam axis 520 as best seen in FIG. 6. Directions transverse to the U-beam axis 520 are generally parallel to the direction 222 (FIG. 5C) of linear tape movement. The blended media facing surface 232 of the chiplet 210 may be fabricated using any suitable cutting, sanding or polishing technique such as using diamond tape to smooth and round the surface 232 as shown in FIGS. 5E, 5F and 6.

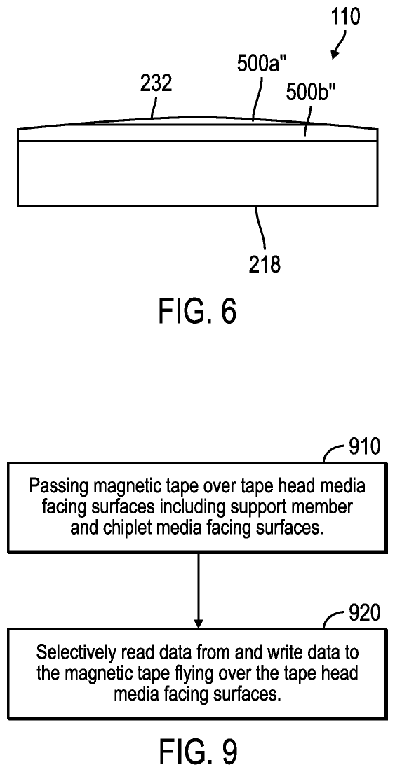

FIG. 7A is a top view of an embodiment of a head 702 in accordance with the present description and FIG. 7B is a lateral cross-sectional view of the head 702 of FIG. 7A, as viewed along the lines 7B-B of FIG. 7A. Representations of components have been simplified and proportions varied within the figures for purposes of clarity in presentation.

In this embodiment, the head 702 includes a wafer chiplet 710 having layers represented at 712a, 712b and having magnetoresistive transducers 714 formed in a gap therein. The chiplet 710 is cut from a wafer such as either of the wafers 316, 318 (FIG. 3) which includes a suitable substrate material and is disposed on and supported by a support structure or member 718, which in the illustrated embodiment, is a ceramic U-beam, to form the tape head 702. It is appreciated that the support member 718 may be constructed of other wear resistant materials.

In one aspect of tape head fabrication in accordance with the present description, the head 702 has media facing surfaces for direct tape contact or for supporting a cushion of air on not only the chiplet 710 but also on each end of the U-beam support member 718 supporting the chiplet 710. In one embodiment, the full lateral width of the chiplet 710 as measured in a direction parallel to the lateral direction 224 (FIG. 7A) is, in one embodiment, narrower in width than the full lateral width of the U-beam member 718 as measured in a direction parallel to the lateral direction 224 (FIG. 2A). The lateral widths are oriented in a direction generally parallel to the lateral direction of movement of the tape head 702 as represented by the arrow 224.

In this embodiment, the U-beam support 718 itself has at one end, a media facing surface 730a to which a media facing surface 732a of the chiplet 710 is smoothly blended at one end of the media facing surface 732a. The other end of the media facing surface 732a of the chiplet 710 is smoothly blended to a top media facing surface 734 of the chiplet 710. Thus, the media facing surface 732a of the chiplet 710 is positioned intermediate to the chiplet media facing surface 734 and the support member media facing surface 730a.

In this embodiment, the blended media facing surface 732a of the chiplet 710 is similar to the media facing surface 232 (FIGS. 2A, 2b) of the chiplet 210. Thus, the media facing surface 732a provides a surface curved in cross-sections parallel to the lateral axis of the U-beam support member 718 to smoothly transition from the plane of the media facing surface 734 of the chiplet 710, to the media facing surface 730 of the U-beam support member 718 as best seem in FIG. 7B. The blended media facing surface 732a of the chiplet 710 is also curved in cross-sections transverse to the lateral axis of the U-beam support member as best seen in FIG. 6 for the head 110.

Furthermore, the U-beam support 718 itself has another media facing surface 730b at its distal end to which a media facing surface 732b of the chiplet 710 is smoothly blended at one end of the media facing surface 732b. The other end of the media facing surface 732b of the chiplet 710 is also smoothly blended to the top media facing surface 734 of the chiplet 710. In this embodiment, the media facing surface 732b is a mirror image of the media facing surface 732a and is positioned intermediate to the chiplet media facing surface 734 and the support member media facing surface 730b.

Here too, such an arrangement provides increased flexibility for manufacturing tape heads having varying numbers of channels and transducers. For example, a chiplet having two banks of transducers, may be used for both single bank and dual bank tape heads, and for both full-height and half-height tape drives, leading to potential cost savings due to use of common chiplet and U-beam support member components in tape heads for these various applications. Furthermore, as best seen in the cross-sectional view of FIG. 7B, smoothly blending media facing surfaces of the chiplet 710 together with media facing surfaces of the U-beam support member 718, reduces or eliminates tape damage due to the tape moving past an edge of the chiplet.

In the embodiment of FIGS. 7A, 7B, the chiplet 710 has two banks of transducers 714, that is, bank 740a and 740b. However, contrary to the embodiment depicted in FIGS. 2A, 2B, both the banks 740a and the 740b are active in read, write and servo operations such that the tape head 710 has 64 data channels in this example. One application of the tape head 710 is use in a full-height tape drive, for example, having 64 data channels, for example. Hence, the tape head 710 is frequently referred to herein as a “full-height tape head” 710. However, it is appreciated that the tape head 710 may also be used in a half-height tape drive, for example.

The full range of head/tape relative lateral motion as indicated by the arrow 746 has a midpoint as indicated by an imaginary center plane 750. In one aspect of head fabrication in accordance with the present description, the full lateral width of the chiplet 710 is less than the full range of head/tape relative lateral motion as represented by the arrow 746 (FIG. 7A). In this embodiment, lateral movement of the head 702 relative to the tape 122 is limited within this range so that a lateral cross-section of the tape is always in contact with or flying over one or more of the U-beam media facing surfaces 730a, 730b and the chiplet media facing surfaces 732a, 732b and 734. Thus, the full range 746 of head/tape relative lateral motion is constrained between two boundaries indicated at 752 (FIG. 7A), 754, respectively, and does not extend beyond the media facing surfaces of the tape head 702. As a result, in this embodiment, the lateral cross-section of the tape does not overhang the lateral ends 760a, 760b (FIG. 7B) of the tape head 702 during read, write or transport operations of the tape 122.

In the illustrated embodiment, an imaginary center plane 750 representing the midpoint of the full range 746 of head/tape relative motion, coincides with the lateral center of the U-beam support member 718. It is appreciated that in other embodiments, the lateral center of the U-beam support member 718 may be offset with respect to the imaginary center plane 750 representing the midpoint of the full range 746 of head/tape relative motion, depending upon the particular application.

In one aspect of head fabrication in accordance with the present description, the

chiplet 710 is disposed on the U-beam support member 718 so that the center between the active banks 740a and 740b of transducers 714 of the chiplet 710 is laterally centered on the midpoint of the full range 746 of head/tape relative lateral motion as indicated by the imaginary center plane 750. As a result, a portion of the tape 122 is overflying the active banks 740a, 740b over the full range 746 of head/tape relative lateral motion for efficient read and write operations. It is appreciated that in other embodiments, the active banks 740a, 740b of transducers 714 of the chiplet 710 may be somewhat off-centered with respect to the midpoint of the full range 746 of head/tape relative motion as indicated by the imaginary center plane 750. However, in such embodiments, a portion of the tape 122 is generally overflying the active banks 740a, 740b over a substantial portion of the full range 746 of head/tape relative lateral motion.

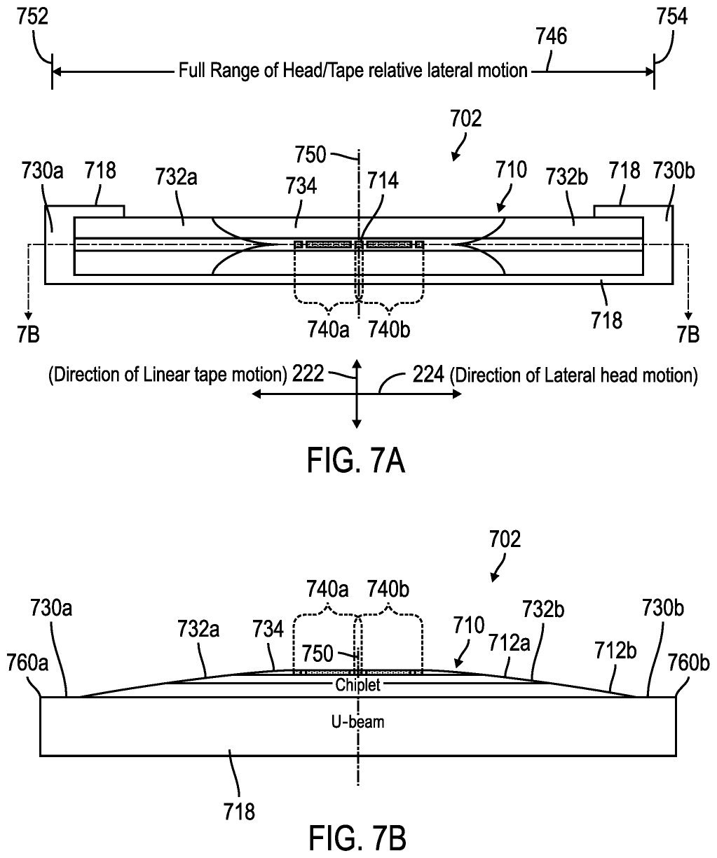

FIG. 8A is a top view of an embodiment of a head 802 in accordance with the present description and FIG. 8B is a lateral cross-sectional view of the head 802 of FIG. 8A, as viewed along the lines 8B-B of FIG. 8A. Representations of components have been simplified and proportions varied within the figures for purposes of clarity in presentation.

In this embodiment, the head 802 includes a wafer chiplet 810 having layers represented at 812a, 812b and having magnetoresistive transducers 814 formed in a gap therein. The chiplet 810 is cut from a wafer such as one of the chiplets 316, 318 (FIG. 3) which includes a suitable substrate material and is disposed on and supported by a support structure or member 818, which in the illustrated embodiment, is a ceramic U-beam, to form the tape head 802. It is appreciated that the support member 818 may be constructed of other wear resistant materials.

In one aspect of tape head fabrication in accordance with the present description, the head 802 has media facing surfaces in contact with the tape or supporting a cushion of air under the tape only on the chiplet 810 and thus lacks media facing surface on either end of the U-beam support member 818 supporting the chiplet 810. In one embodiment, the full lateral width of the chiplet 810 as measured in a direction parallel to the lateral direction 224 (FIG. 8A) matches, in one embodiment, that of the full lateral width of the U-beam member 818 as measured in a direction parallel to the lateral direction 224 (FIG. 2A). The lateral widths are oriented in a direction generally parallel to the lateral direction of movement of the tape head 110 as represented by the arrow 224.

In this embodiment, a media facing surface 832a of the chiplet 810 is smoothly blended at one end 834a of the media facing surface 832a, and the other end of the media facing surface 832a of the chiplet 810 is smoothly blended to a top media facing surface 834 of the chiplet 810.

In this embodiment, the blended media facing surface 832a of the chiplet 810 is similar to the media facing surface 232 (FIGS. 2A, 2b) of the chiplet 210. Thus, the media facing surface 832a provides a surface curved in cross-sections parallel to the lateral axis of the U-beam support member 818s to smoothly transition from the plane of the media facing surface 834 of the chiplet 810, to the end 834a of the media facing surface 832a of the chiplet 810 as best seem in FIG. 8B. The blended media facing surface 832a of the chiplet 810 is also curved in cross-sections transverse to the lateral axis of the U-beam support member as best seen in FIG. 6 for the head 110.

Furthermore, the chiplet 810 has another media facing surface 832b which is a mirror image of the media facing surface 832a. Thus, the media facing surface 832b of the chiplet 810 is smoothly blended at one end 834b of the media facing surface 832b. The other end of the media facing surface 832b of the chiplet 810 is also smoothly blended to the top media facing surface 834 of the chiplet 810.

Here too, such an arrangement provides increased flexibility for manufacturing tape heads having varying numbers of channels and transducers. For example, a chiplet having two banks of transducers, may be used for both single bank and dual bank tape heads, leading to potential cost savings due to use of common chiplet and U-beam support member components in both half-height and full-height tape drives. Furthermore, as best seen in the cross-sectional view of FIG. 8B, smoothly blending media facing surfaces 832a, 832b, 834 of the chiplet 810, reduces or eliminates tape damage due to the lateral cross-section of the tape moving past the lateral edges 834a, 834b of the chiplet.

In the embodiment of FIGS. 8A, 8B, the chiplet 810 has two banks of transducers 814, that is, bank 840a and 840b. However, contrary to the full-height embodiment depicted in FIGS. 7A, 7b, only one bank 840a is active in read, write and servo operations such that the tape head 802 effectively has 32 channels in this example. One application of the tape head 802 is use in a half-height tape drive, for example, having 32 data channels, for example. Hence, the tape head 802 is frequently referred to herein as a “half-height tape head” 802. However, it is appreciated that the tape head 902 may also be used in a full-height tape drive, for example.

The full range of head/tape relative lateral motion as indicated by the arrow 846 has a midpoint as indicated by an imaginary center plane 850. In one aspect of head fabrication in accordance with the present description, the full lateral width of the chiplet 810 and its supporting U-beam support member 818 are both less than the full range of head/tape relative lateral motion as represented by the arrow 846 (FIG. 8A). In this embodiment, the full range of head/tape relative lateral motion as indicated by the arrow 846 extends beyond and over hangs the edges 834a, 834b of the tape head 802 during read, write or transport operations of the tape 122.

In the illustrated embodiment, an imaginary center plane 850 representing the midpoint of the full range 846 of head/tape relative motion, coincides with the lateral center of the U-beam support member 818. It is appreciated that in other embodiments, the lateral center of the U-beam support member 818 may be offset with respect to the imaginary center plane 850 representing the midpoint of the full range 846 of head/tape relative motion, depending upon the particular application.

In one aspect of head fabrication in accordance with the present description, the chiplet 810 is disposed on the U-beam support member 818 so that the center of the active bank 840a of transducers 814 of the chiplet 810 is laterally centered on the midpoint of the full range 846 of head/tape relative lateral motion as indicated by the imaginary center plane 850. As a result, a portion of the lateral cross-section of the tape 122 is overflying or in contact with the active bank 840a over the full range 846 of head/tape relative lateral motion for efficient read and write operations. It is appreciated that in other embodiments, the active bank 840a of transducers 814 of the chiplet 810 may be somewhat off-centered with respect to the midpoint of the full range 846 of head/tape relative motion as indicated by the imaginary center plane 850. However, in such embodiments, a portion of the lateral cross-section of the tape 122 is generally overflying or in contact with the active bank 840a over a substantial portion of the full range 846 of head/tape relative lateral motion.

Conversely, because the inactive bank 840b of transducers 814 is substantially offset with respect to the imaginary center plane 850 representing the midpoint of the full range 846 of head/tape relative motion, a portion of the cross-section of the tape 122 overflying or in contact with the inactive bank 840b over much of the full range 846 of head/tape relative lateral motion is not assured. However, because the bank 840b is inactive, read and write operations of the half-height head 802 is not affected by the inactive bank 840b of transducers being offset with respect to the center of the U-beam support member 818 or the full range 846 of head/tape relative lateral motion.

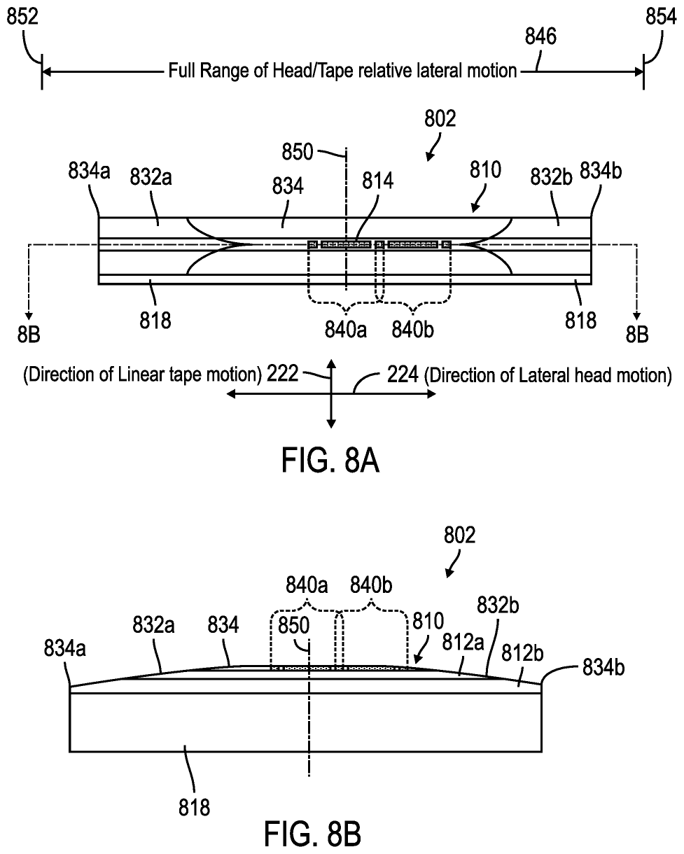

FIG. 9 depicts one example of tape drive operations of the tape drive controller 128 (FIG. 1) of a tape drive 100 having a tape head in accordance with one embodiment of the present description. As shown in FIG. 9, the tape drive operations of the controller 128 in this example are represented by blocks 910-920 of FIG. 9. It is appreciated that the number and types of operations of a tape drive controller 128 of a tape drive in accordance with embodiments of the present description, may vary, depending upon the particular application. Furthermore, operations may be performed in sequences other than those depicted in FIG. 9. For example, operations may be performed in reverse order or substantially in parallel, depending upon the particular application.

In the embodiment of FIG. 9, the operations include passing (block 910, FIG. 9) magnetic tape over tape head media facing surfaces including support member and chiplet media facing surfaces in accordance with the present description, and selectively reading (block 920, FIG. 9) data from and writing data to the magnetic tape passing over the tape head media facing surfaces. For example, the magnetic tape 122 (FIG. 1) may be actuated to move in a linear direction 222 (FIG. 2A) past the tape head 110 by actuating reels 120, 121 (FIG. 1) of the tape drive 100 so that the magnetic tape flies over or is in contact with media facing surfaces of the tape head 110 including the media facing surface 230 (FIG. 2A) of the U-beam support member 218 of the tape head 110, and the media facing surface 234 of the chiplet 210 disposed on the U-beam support member 218. In one embodiment, the lateral width of the chiplet 210 is less than the lateral width of the U-beam support member 218 so that passing the magnetic tape 122 (FIG. 1) over the media facing surface 234 of the chiplet 210 includes the passing tape overhanging an edge of the chiplet 210 so that the tape also passes over the media facing surface 230 (FIG. 2A) of the U-beam support member 218 of the tape head 110.

For example, in one embodiment, passing the tape to overhang a lateral edge of the chiplet 210 includes passing the magnetic tape over another media facing surface 232 of the chiplet 210. In this example, the media facing surface 232 of the chiplet 210 is a curved surface positioned intermediate the media facing surface 230 of the U-beam support member 218, and the media facing surface 234 of the chiplet 210. The media facing surface 232 of the chiplet 210 is a curved surface to reduce or eliminate damage to the tape overhanging a lateral edge of the chiplet 210 while passing over the tape head 110. More specifically, in one embodiment, the curved media facing surface 232 of the chiplet 210, is curved to transition from a plane defined by the media facing surface 230 of the U-beam support member 218, to a plane defined by the media facing surface 234 of the chiplet 210. Still further, in one embodiment, the media facing surface 232 of the chiplet 210 is a media facing surface which is polished so as to be curved both in a direction parallel to the tape linear direction 222 and in a direction parallel to the tape head lateral direction 224. Such curvature further enhances the capability of the media facing surface 232 of the chiplet 210 to reduce or eliminate damage to the tape resulting from overhanging the lateral edge of the chiplet 210 while passing over the tape head 110.

In one embodiment, passing the tape over the tape head 110 further includes actuating the tape head so that the tape head 110 moves relative to the magnetic tape, in a lateral direction 224 transverse to the tape linear direction 222. In one aspect of tape drive operation in accordance with the present description, the tape head is caused to laterally move relative to the magnetic tape over a predetermined range 246 of tape head and magnetic tape relative lateral motion, which exceeds the lateral width of the chiplet 210. As a result, passing the magnetic tape 122 (FIG. 1) over the media facing surfaces of the chiplet 210 can include the tape passing over the media facing surface 230 (FIG. 2A) of the U-beam support member 218 of the tape head 110.

In another aspect of operating a tape drive having a tape head in accordance with the present description, selectively reading data from and writing data to the magnetic tape passing over media facing surfaces of the tape head includes in one embodiment, using a bank of active transducers such as the bank 240a (FIG. 2A) which is centered on the U-beam support member 218, and excludes using the second bank 240b of inactive transducers which is offset from the center of the U-beam support member 218. As a result, a chiplet such as the chiplet 210 having two banks of transducers, may be used for a half-height application instead of a full-height application, or for a 32 data channel application instead of a 64 data channel application.

In one embodiment, a head such as the tape head 110 may be assembled in a module and a tape drive may have one or more such modules. Modules may be joined together with a space present between closures to form a single physical unit to provide read-while-write capability by activating the writer of the leading module and reader of the trailing module aligned with the writer of the leading module parallel to the direction of tape travel relative thereto. A chiplet of a head may be constructed in layers. For example, layers may be formed in a gap created above an electrically conductive substrate e.g., of AlTiC, in generally the following order for a reader module: an insulating layer, a first shield typically of an iron alloy such as NiFe (permalloy), CZT or Al—Fe—Si (Sendust), a sensor for sensing a data track on a magnetic medium, and a second shield typically of a nickel-iron alloy (e.g., 80/20 Permalloy). In another example, for a writer module, a substrate e.g., of AlTiC, followed by an insulating layer, followed by first and second writer pole tips, and a coil. The first and second writer poles may be fabricated from ferromagnetic materials such as 45/55 NiFe. Note that these materials are provided by way of example only, and other materials may be used. Additional layers such as insulation between the shields and/or pole tips and an insulation layer surrounding the sensor may be present. Illustrative materials for the insulation include alumina and other oxides, insulative polymers, etc.

The controller 128 and the computer 140 of FIG. 1 are described as performing various logic functions. In one embodiment, the controller 128 and the computer 140 includes processors which cause operations which perform the various logic functions. Alternatively, one or more of these logic functions may be performed by one or more of programmed centralized processors such as central processing units (CPUs) and programmed distributed processors such as integrated circuit logic devices such as Application Specific Integrated Circuit (ASIC) devices, for example. Programming of such hardware may be provided by one or more of software and firmware alone or in combination, and stored in a memory. In other embodiments, some or all of the logic functions of the controller 128 and computer 140 may be performed by dedicated or hard-wired logic circuitry.

One or more of the controller 128 and computer 140 may be implemented as program modes which may comprise routines, programs, objects, components, logic, data structures, and so on that perform particular tasks or implement particular abstract data types. The program components and hardware devices of the tape drive 100 of FIG. 1 may be implemented in one or more computer systems, where if they are implemented in multiple computer systems, then the computer systems may communicate over a network.

The present invention may be a system, device, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing g. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A device for data storage on storage media, comprising:
a head having:
a support member having a first media facing surface adapted to face moving media; and
a wafer chiplet disposed on the support member and having head transducers formed in the chiplet and adapted to at least one of read data from and write data to media moving past the head transducers, the wafer chiplet further having a second media facing surface adapted to face moving media.

2. The device of claim 1 wherein the head is a tape head, and the media is magnetic tape and is adapted to move in a linear direction, wherein the support member and the wafer chiplet each have lateral widths in a lateral direction transverse to the tape linear direction and wherein the lateral width of the chiplet is less than the lateral width of the support member.

3. The device of claim 2 wherein the device is for use with tape head actuators adapted to cause lateral motion of the tape head relative to the magnetic tape, in a lateral direction transverse to the tape linear direction, and over a predetermined range of tape head and magnetic tape relative lateral motion, wherein the wafer chiplet has a lateral width in a lateral direction transverse to a tape linear direction and wherein the lateral width of the chiplet is less than the predetermined range of tape head and magnetic tape relative lateral motion.

4. The device of claim 2 wherein the chiplet has a third media facing surface adapted to face moving magnetic tape, wherein the third media facing surface is a curved surface positioned intermediate the first media facing surface of the support member, and the second media facing surface of the chiplet.

5. The device of claim 2 wherein the support member defines a center, wherein the tape head has a first bank of transducers and a second bank of transducer and wherein the chiplet is disposed on the support member so that the first bank of transducers of the tape head is centered on the support member and the second bank of transducers is offset from the center of the support member.

6. The device of claim 4 wherein the first media facing surface defines a first plane, the second media facing surface defines a second plane offset from the first plane, and the third media facing surface is curved to transition from the second plane to the first plane.

7. The device of claim 6 wherein the support member is a ceramic U-shaped member which defines a lateral axis and wherein the curved shape of the third media facing surface is a polished surface which is curved both in a direction parallel to the U-shaped member lateral axis and in a direction transverse to the U-shaped member lateral axis.

8. The device of claim 4 wherein the support member has a fourth media facing surface adapted to facing moving magnetic tape, wherein the chiplet has a first end adjacent the support member first media facing surface and a second end adjacent the support member fourth media facing surface, and wherein the chiplet has a fifth media facing surface adapted to face moving magnetic tape and wherein the fifth media facing surface is a curved surface positioned intermediate the second and fourth media facing surfaces.

9. A method for operating a tape drive for magnetic tape and having a tape head having a wafer chiplet and a support member supporting the chiplet, wherein the computer program product comprises a computer readable storage medium having program instructions embodied therewith, the program instructions executable by a processor to cause operations, the operations comprising:
actuating magnetic tape including moving the magnetic tape in a linear direction past the tape head of the tape drive; and
actuating the tape head including moving the tape head relative to the magnetic tape, in a lateral direction transverse to the tape linear direction;
wherein moving the magnetic tape and the tape head includes passing the magnetic tape over a first media facing surface of the support member of the tape head, passing the magnetic tape over a second media facing surface of the chiplet disposed on the support member, and passing the magnetic tape over a third media facing surface of the chiplet which is a curved surface positioned intermediate the first media facing surface of the support member, and the second media facing surface of the chiplet, and
selectively reading data from and writing data to the magnetic tape passing over media facing surfaces of the tape head using a first bank of active transducers formed in the chiplet and centered on the support member, and excludes using a second bank of inactive transducers formed in the chiplet and offset from the center of the support member.

10. The method of claim 9 wherein a lateral width of the chiplet is less than a lateral width of the support member so that passing the magnetic tape over the second media facing surface of the chiplet includes the passing tape overhanging an edge of the chiplet wherein the tape also passes over the first media facing surface of the support member of the tape head.

11. The method of claim 9 wherein moving the tape head relative to the magnetic tape, in a lateral direction transverse to the tape linear direction includes laterally moving the tape head relative to the magnetic tape over a predetermined range of tape head and magnetic tape relative lateral motion, which exceeds a lateral width of the chiplet.

12. The method of claim 9 wherein passing the magnetic tape over the third media facing surface of the chiplet includes passing the magnetic tape over a curved third media facing surface which is curved in a direction parallel to the tape head lateral direction to transition from a plane defined by the first media facing surface of the support member to a plane defined by the second media facing surface of the chiplet, and is curved in a direction parallel to the tape linear direction.

13. A tape drive for data storage on magnetic tape, comprising:
a tape head having a support member having a first media facing surface adapted to face moving magnetic tape and a wafer chiplet disposed on the support member and having tape head transducers formed in the chiplet and adapted to at least one of read data from and write data to magnetic tape moving past the tape head transducers, the wafer chiplet further having a second media facing surface adapted to face moving magnetic tape;
linear actuators configured to move the magnetic tape in a linear direction past the tape head; and
lateral actuators configured to cause lateral motion of the tape head relative to the magnetic tape, in a lateral direction transverse to the tape linear direction.

14. The tape drive of claim 13 wherein the support member and the wafer chiplet each have lateral widths in the lateral direction transverse to the tape linear direction and wherein the lateral width of the chiplet is less than the lateral width of the support member.

15. The tape drive of claim 13 wherein the lateral actuators are adapted to cause lateral motion of the tape head relative to the magnetic tape, in a lateral direction transverse to the tape linear direction, and over a predetermined range of tape head and magnetic tape relative lateral motion, and wherein the wafer chiplet has a lateral width in a lateral direction transverse to a tape linear direction and wherein the lateral width of the chiplet is less than the predetermined range of tape head and magnetic tape relative lateral motion.

16. The tape drive of claim 13 wherein the chiplet of the tape head has a third media facing surface adapted to face moving magnetic tape, wherein the third media facing surface is a curved surface positioned intermediate the first media facing surface of the support member, and the second media facing surface of the chiplet.

17. The tape drive of claim 13 wherein the support member of the tape head defines a center, wherein the tape head has a first bank of transducers and a second bank of transducer and wherein the chiplet is disposed on the support member so that the first bank of transducers of the tape head is centered on the support member and the second bank of transducers is offset from the center of the support member.

18. The tape drive of claim 16 wherein the first media facing surface of the support member defines a first plane, the second media facing surface of the chiplet defines a second plane offset from the first plane, and the third media facing surface of the chiplet is curved to transition from the second plane to the first plane.

19. The tape drive of claim 18 wherein the support member of the tape head is a ceramic U-shaped member which defines a lateral axis and wherein the curved shape of the third media facing surface is a polished surface which is curved both in a direction parallel to the U-shaped member lateral axis and in a direction transverse to the U-shaped member lateral axis.

20. The tape drive of claim 16 wherein the support member of the tape head has a fourth media facing surface adapted to facing moving magnetic tape, wherein the chiplet of the tape head has a first end adjacent the support member first media facing surface and a second end adjacent the support member fourth media facing surface, and wherein the chiplet has a fifth media facing surface adapted to face moving magnetic tape and wherein the fifth media facing surface is a curved surface positioned intermediate the second and fourth media facing surfaces.
